(19) United States
(12) Patent Application Publication
(10) Pub. No.: US 2005/0225919 A1
(43) Pub. Date: Oct. 13, 2005

(54) Intelligent electric switching device for securing electricity distribution means

(76) Inventor: Michel Combier, Gif Sur Yvette (FR)

Correspondence Address: PERMAN & GREEN, 425 POST ROAD, FAIRFIELD, CT, 06824, US

(21) Appl. No.: 10/896,688

(22) Filed: Jul. 22, 2004

(30) Foreign Application Priority Data
Jul. 25, 2003 (FR) FR0309103

(51) Int. Cl. H01H 73/00

(52) U.S. Cl. 361/115

(57) ABSTRACT

The present invention concerns an intelligent electric switching device designed to secure electric energy distribution systems; the device is characterized in that it includes, in a single physical unit: an electric switch through which an electric power network passes; a measurement means assembly including one or more measurement means; a network communication means, connected to a communication network; a memory storage means permitting storing all the measurements conducted on the electric switching device an the data coming from the communication network means; a decision means analyzing the stored and controlling the electric switch; decision means being connected to electric switch, to measurement means, to communication network means and to memory-storage means.

The present invention concerns the creation of a low-voltage and high-current electric switching device for securing electricity distribution means and the associated electric energy management network. The device has its own capacity for decision and internal actions to assure optimal automated management of the acquisition, storage and consumption of electric energy while preserving the safety of equipment and personnel.

Electric switching devices are known in the prior art, for the most part made up of a mechanical switch with manual or automatic control. Automatic control can be executed as a function of physical measurements concerning the device, said measurements being conducted by measurement means external to the device. These devices have the disadvantage of not being very autonomous due to the fact that they have few sensors and detectors available. These devices do not communicate with other power elements, such as a charger or a regulator, elements that may belong to the electric energy distribution system. Communication among the different elements of the system would permit an optimization of the management of electricity and could correct a failure of the electricity management system. The current need for safety devices able to interrupt the distribution of electricity if an incident occurs renders such a device indispensable in numerous types of vehicles, notably for transport of dangerous materials.

The object of the present invention is to alleviate certain disadvantages of the prior art by proposing an intelligent electric switching device for securing electricity distribution systems and the associated electric energy management network. This device proposes a solution of totally autonomous switch architecture for reasons of safety of operation, but also makes available communication means permitting it to function in association with other switches of the same type or other equipment used in electric management.

This object is attained by an intelligent electric switching device, which is designed for securing a system of electric power distribution comprising different power elements; the electric switching device is characterized in that it comprises, in a single physical unit:
an electric switch through which an electric power network passess;
a measurement means assembly comprising one or more measurement means, each of a different type, making physical measurements of the electric switching device;
a network communication means, connected to a communication network, said network being connected to power elements of the distribution system, said communication means permitting sending the characteristic parameters of the state of the electric switching device to the communication network and permitting receiving the characteristic parameters of the state of different power elements of the electric energy distribution system, connected to the communication network;
a memory storage means permitting storing all the data originating from the measurements conducted by the measurement means assembly, and data received by the network communication means on the characteristics of different power elements connected to the communication network (8);
a decision means simultaneously and locally analyzing all the data stored in the memory storage means and the measurements conducted, the decision device controlling the switching off or on of the electric switch as a function of its analysis;
   the decision means being connected to the electric switch, to the measurement means, to the communication network means and to the memory storage means.

According to another particular characteristic, the electric switching device operates in autonomous mode by means of the assembly of measurement means, memory storage means and decision means, the decision means making decisions in a local manner on the basis of measurements stored in the memory storage means as well as measurements conducted in real time.

According to another particular point, the electric switch of the electric switching device comprises an insulating disk provided with a conductive zone crossing through the disk, said disk being rotated by an axle, said axle being moved directly by a motor that can be controlled by the decision means or by a command button situated on the electric switch, electrical contact of the electric switch being assured by means of at least two electrodes, one connected to the current source, the other connected to the charge and being in contact with the conductive zone when the electric switch is in the closed [“on”] position.

According to another particular characteristic, the electric switch motor is a motor supporting a manual mechanical activation.

According to another particular characteristic, the electric switching device can function in manual mode by activation by a user of the command button situated on the electric switch, which, by means of the switch axle will induce the rotation of the disk and connect or disconnect the power network.

According to another particular characteristic, the electric switching device can function in network mode via the means for network communication and data exchange with the power elements of the electric energy distribution system connected to the communication system.

According to another particular characteristic, the network communication means is a fixed telephonic means of the optoelectronic or current-carrying type or the network communication means is a radio-type wireless means.

According to another particular characteristic, the electric energy switching device can be inserted into an electric energy management network, said electric energy management network being connected to one or more power elements, which belong to a system of electric energy distribution, the electric energy management network comprising a power network carrying the electric energy and a communication network carrying data concerning the management of the electric energy, the two networks being connected to power elements of the energy distribution system, said power elements being removable and interchangeable and each having their own decision means.

According to another particular characteristic, the electric energy management network can be connected to a control means interfacing with a user, said interface permitting parameterizing the network, controlling the functions of the electric energy distribution system, and monitoring the state of all the elements connected to the network.

According to another particular characteristic, the electric energy management network functions in centralized mode when the communication network is fully available, permitting a user to activate a certain number of commands of the electric energy distribution system by means of the control means.

According to another particular characteristic, the electric energy management network functions in decentralized mode, permitting all the elements of the electric energy distribution system to communicate among themselves, each element being totally autonomous.

According to another particular characteristic, the electric energy management network functions in default mode, when the communication network is out of service, and the elements of the electric energy distribution system make their decision locally based on their own measurements.

Other particular characteristics and advantages of the present invention will appear more clearly upon reading the description below in reference to the attached drawings, in which:

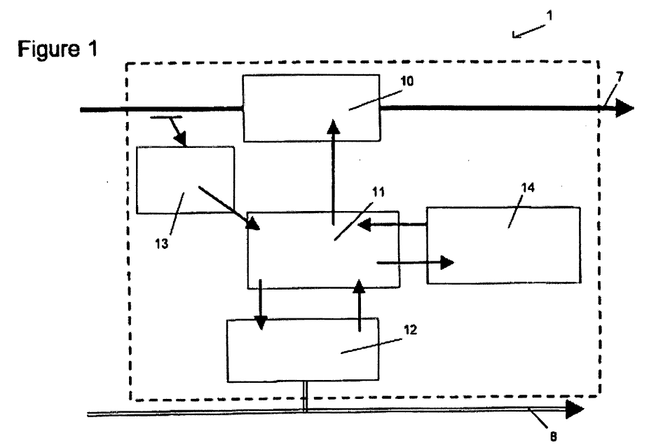

FIG. 1 shows a block diagram of the elements making up the electric switching device, according to one embodiment of the present invention;

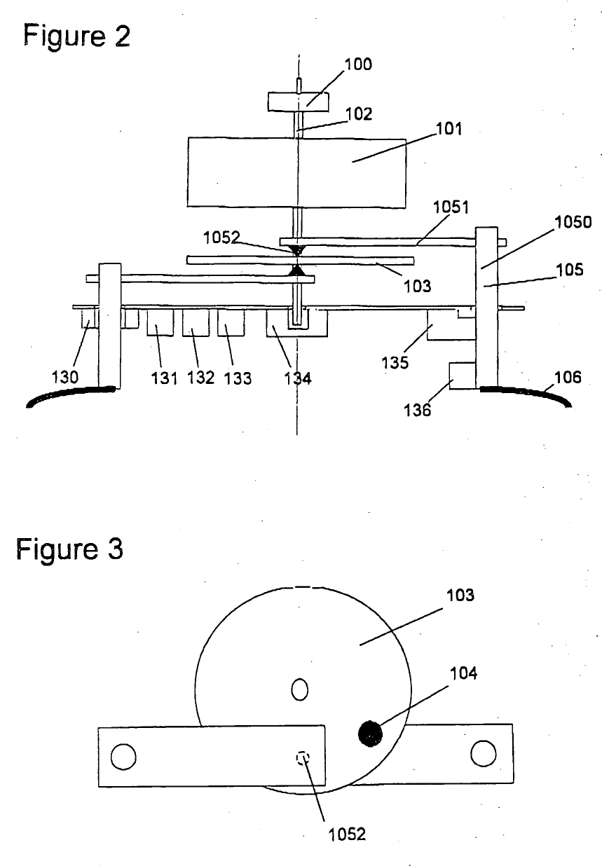

FIG. 2 shows a diagram representing the switch of the electric switching device, according to one embodiment of the present invention;

FIG. 3 shows a top view of the disk of the electric switch of the electric switching device of the present invention;

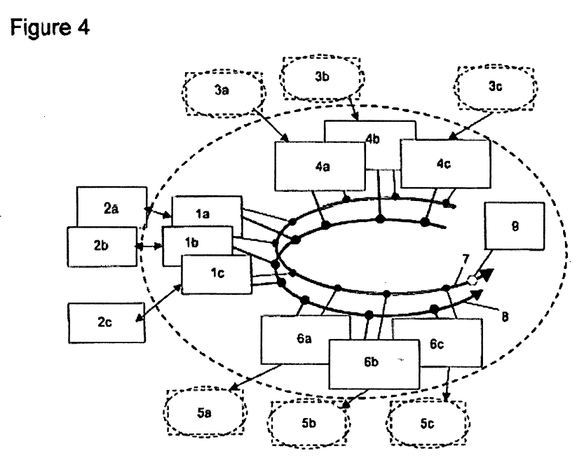

FIG. 4 shows a diagram representing the energy distribution network to which the electric switching device of the present invention is connected.

FIG. 1 shows a block diagram of the elements making up the electric switching device (1), according to one embodiment of the present invention. Electric switching device (1), also called battery isolation switch, comprises an electric switch (10) of very high intensity, a decision means (11) receiving all the data concerning the state of the electricity distribution system and electric switching device (1), a measurement means assembly (13) permitting decision means (11) to conduct all the necessary physical measurements, and a communication means (12) connected to an external communication network (8) for electric switching device (1). Electric switch (10) is connected to an electric power network (7) and serves as a breaker, permitting disconnecting or connecting electric power network (7). The turning off and on of switch (10) is controlled automatically by decision means (11). Decision means (11) relies on the physical measurements conducted by measurement means assembly (13), on internal parameters stored in a memory storage means (14), and by data exchanged with other power devices connected to the electric energy management network. Decision means (11) is connected to communication means (12), which is in turn directly connected to a communication network (8). Communication means (12) permits decision means (11) to obtain data on the different power devices of an electric energy distribution system that are connected to the electric energy management means.

Electric switching device (1) of the invention, and its means for action and decision are combined within a single physical entity, which is capable of operating in many ways. Device (1) can function in an autonomous manner, due to its measurement means (13), memory storage means (14) and decision means (11), if communication means (12) is out of service. Device (1) can operate in a network due to its communication means (12), if measurement means (13) is out of service. Device (1) can operate by making its decision on the basis of internal measurements and measurements originating from its immediate environment (temperature, voltage of the electric network, current taken up or supplied by the network), all the measurements being stored in memory storage means (14). Device (1) can operate manually. Except for switch (10) itself, any of its components can be out of service without affecting the possibility of direct and local manual control, for example, in the case of an emergency. All these modes of operation are explained in a little more detail in the following part of the description.

The switch is presented in reference to FIGS. 2 and 3. FIG. 2 shows a representative diagram of electric switch (10) of electric switching device (1), according to one embodiment of the present invention. Electric switch (10) is made up of an insulating disk (103) provided with at least one conductive zone (104) positioned in an opening of disk (103) shown in FIG. 3. This opening is situated close to the radial midpoint of disk (103). Disk (103) is rotated by an axle (102) that passes through and is attached to disk (103) in an opening (107) situated in the middle of disk (103). This axle (102) can be directly moved, without reducer mechanism by a motor (101) and a command button (100) situated on electric switch (10). Switch (10) comprises two electrodes (105) thus assuring electric contact and connection to current sources (106). Each electrode (105) comprises a flexible strip (1051) made of conductive material and attached in a perpendicular manner to a conductive bar 1050 connected to one end of a current source (106). On one end of flexible strip (1051), close to disk (103), is attached a conductive tip (1052) which can be contacted with conductive zone (104) of disk (103). The electrodes are positioned on each side of the disk in a manner such that there is conductivity between tips (1052) of the electrodes and conductive zone (104) when a command for closing or turning on the electric power circuit is requested. Let us suppose initially that switch (10) is in open [“off”] position. Conductive zone (104) is not in contact with the electrode tips (1052). When a turn-on command is issued, disk (103) will be rotated by axle (102), axle (102) being controlled by motor (101). The rotation is terminated as soon as conductive zone (104) of disk (103) is in contact with tips (1052) of electrodes (105). In order to define this position, at least one measurement means (134) is positioned on the electronic board of switch (10), permitting detecting the position of conductive zone (104) of disk (103). This limit sensor (134) also permits detecting manual activation when a user activates switching button (100) situated on switch (10). This manual activation will command the rotation of motor (101). The functions of detection of manual activation and limit detection of disk (103) are assured by an electrical or optical sensor (134). Motor (101), or any other equivalent device, is characterized by its capacity to support a manual activation of its rotation axle (102) by the command button, or to be activated electrically by electronic command. A “step” motor is particularly well suited to this usage.

This arrangement or any other equivalent layout of device (1) permits making up a safe, strong and flexible electric switch (10). Switch (10) is reliable: the switching maneuver does not involve any mass displacement, rocking of a lever or the like. The switch is thus insensitive to shocks and vibrations. Switch (10) is strong: wear is not a concern, except with regard to friction contacts (104-1052), which can be made of an appropriate material combining low electrical resistance and good resistance to wear. Switch (10) is flexible: rotating disk (103) can be provided with a variable number of contacts (104), thus permitting the creation of a switch (10) in many ways without exceeding its basic technical principles.

Measurement means assembly (13) of electric switching device (1) is mounted directly on the electronic board which also supports the various components assuring the functions of decision and communication. Measurement means assembly (13) comprises a magnetic current sensor (130), a temperature sensor (135), a voltage sensor (136), a shock sensor (131), an attitude sensor (132), [and] a humidity sensor (133). This assembly of means is non-limiting and can be supplemented by sensors appropriate to the use of the device.

This arrangement, or any other equivalent layout, permits making up a very inexpensive battery isolation switch. It requires only a small number of parts, of simple forms, without very high adjustment precision and without final wiring. This arrangement assures, by the reduction of cables and connectors, a very great safety of operation for a very low cost.

Device (1) can operate in manual mode in different situations: a total electronic breakdown or a breakdown of motor (103) of device (1) can occur; communication means (12) can be out of service either due to a limited electronic breakdown of the device, or due to an equipment failure of network (8), or because there is no other means for switching in. Device (1) cannot make a local decision due to a lack of data or “experience” of the system. During manual operation, a user activates a command button (100) which, by means of axle (102) will induce rotation of disk (103) and connect or disconnect circuit (7). The technology of motor (101) permits the latter to be maneuvered either live or without current without degradation. Detector (134) permits the electronics to detect said action if they are in a state to do so, and consequently to operate this new state, for example, by communicating with the outside by the network, or to take into account this command in order to prevent triggering an automatic action contrary to the manual action. Detector (134) also permits detecting incomplete operations, due to vibrations, shocks or access difficulties of an operator, and permits the electronics to complete these operations, thus assuring a correct positioning of contacts (1052) of switch (10). Manual operation is not incompatible with the other modes of operation, but in case of conflict, it is the manual command that has priority and induces deactivation of automatic mechanisms. Return to automatic mode is achieved by subsequent reconnection.

The device can operate in autonomous mode. The battery isolation switch has its own capacity for decision-making. This permits, moreover, the addition or elimination of power elements while operating connected to the electric energy management network. Thus, no network reconfiguration is necessary since all the elements can only read the data carried on the network. The autonomous mode of the device also permits assuring a continuous operation even in the case of loss of communication network (8). The different power elements of the electric energy distribution system, connected normally to communication network (8) no longer receive data. They continue to assure their service on the basis of the last data received from measurements conducted locally. In this case, their learning capacity permits them to estimate certain parameters.

Device (1) can operate in a network due to communication network means (12) connected to communication network (8), while permitting obtaining or sending data concerning the different power elements of an electric energy distribution system. By means of its decision, communication and action capacities, electric switching device (1) can be integrated in a complex network of electric energy management. The object of the invention is to propose a network architecture solution with distributed intelligence, both material and operational, permitting automating, optimizing and securing the supply of electric energy regardless of communication conditions. FIG. 3 shows an electricity management network. The latter comprises two networks: a power network (7) carrying electric energy and a communication network (8) permitting the different power elements participating in management to communicate with each other. This energy network can comprise one or more primary sources (3) associated with their charger(s) (4), one or more batteries (2) associated with their battery isolation switch(es) (1), one or more regulators (6) controlled by specific usages (5), one or more means for user control (9) such as a computer. The controller is the principal interface with the user. It permits parameterizing the entire network, for example the breaking current or the battery capacity. It permits controlling all the functions such as general on/off and all the desired manual commands. It can be shut off or eliminated without affecting the state and the electric network configuration. Any action will then be manual, directly at the level of the battery isolation switches. In the case where reliability is not extremely important, it can be replaced by simple computer software.

Optimal management of this network requires that chargers (4), battery isolation switch (1), regulators (6) and user control means (9) can communicate with each other; this is the role of communication network (8). The originality of device (1) is characterized by the fact that communication network (8) connects the different power elements in the same way as power network (7) and that there is no central control element. The overall behavior is always the result of local actions assured individually by each element. No element connected to this network ever sends an order to another element. It regularly limits sending data relative to its state as well as the various parameters which characterize its state such as the circulating current, the present voltage, or the estimate of available charge. Every element connected to this network monitors all the data present on the network in order to deduce the best action to take locally. In order to fulfill in a satisfactory manner the safety requirements for operation of an electric energy management network, it is therefore necessary that each element (source (3)/charger (4)/regulator (6)) is capable of making local decisions solely on the basis of what it has learned beforehand and also on the basis of measurements taken locally or that can be taken by its immediate neighbors. Each element has its own decision capacity, which permits the addition and removal of operational elements in the network; no reconfiguration is necessary since all the elements only read information from the network. The autonomy of the power elements permits also assuring continuous operation even in the case of loss of communication network (8). In this case their learning capacity permits them to estimate certain parameters, and their decision capacity permits them to deduce quasi-optimal actions.

Electric switching device (1), according to the present invention, fully conforms to the requirements of the electricity distribution system. It has available communication means (12) and remote control permits it to operate collectively both with other classes of power elements (chargers (4) and regulators (6)) and with its homologues (other battery isolation switches (1)). Due to its strategic position in the electric network, switching device (1) is capable of monitoring the principal energy flows and can carry out the majority of physical measurements necessary for the other neighboring elements of the energy distribution system. These other elements (charger (4), regulator (6)) can then have a simplified technology that does not comprise complex sensors. The decision means and the learning means of the electric switching device permit it to record the majority of characteristic situations. The decision means integrated in each element of the device, such as a microcontroller, can be identical for all the elements, which simplifies the design and permits reducing the development and adaptation costs. The invention permits device (1) to always assure a minimum service regardless of the state of degradation of the communication means or the various constituent components.

The energy distribution network can function according to several modes. A first mode is the centralized mode. This is the traditional mode, used when the communication means is fully available and when the user wishes to activate a certain number of commands such as start, stop, or programming of various parameters such as breaking thresholds. Another mode is the decentralized mode. All the elements can still communicate with one another but the device assembly is totally autonomous. This is the standard operating mode where the system must be self-managing. A last mode is the default mode. The various elements no longer communicate by the data network either due to interference, accidental disconnection or even distance. The elements of the device will make their decisions locally solely on the basis of the measurements that they can take. Although actions are undertaken in an individual manner, it will be observed that the collective behavior of the device remains very close to optimal.

The energy distribution system has a chain reaction capacity which permits an element to make a local decision, execute the corresponding action, inform the other elements, and thus modify the general system, which can lead to the origin of a new decision on the part of another component. This reaction capacity permits the system to manage very complex situations without requiring the implementation of complex local algorithms. The application of this very general concept to the problem of electric energy management constitutes the substance of the present invention. All configurations are possible, from the simplest configuration consisting of a single battery (2) with its circuit-breaker (1) up to configurations comprising several sources (3), several storage [battery] units (2) and several charges (4). The electric energy management network as well as the management algorithms remain identical. The application of principles established beforehand permits this device to guarantee the supply of electricity with a level of reliability inaccessible to current systems.

The electric energy distribution system proposed is designed more particularly for isolated plants where the availability of energy cannot be guaranteed in a predictable manner, where consumption is also variable and difficult to monitor, and finally where an experienced operator cannot always be present: ships, trucks, autonomous surveillance stations. The system is also applicable to all autonomous systems of acquisition, storage, distribution, or consumption of electric energy for which safety, security and simplicity of use are of extreme importance.

The device according to the invention is particularly designed for electric management of mobile units and isolated electric stations and permits, at a very modest additional cost, better management of the electricity available without uselessly requiring recourse to unavailable recharging means. The device also permits assuring a great safety due to the fact of permanent and automatic surveillance of the available means. The device also permits guaranteeing a great security of operation due to the absence of a central control component and the capacity to operate despite the loss of certain elements or even of the communication network.

The device, according to the invention, is also designed for energy management, notably for boats or isolated stations where, in addition to security, optimal management of electric energy is essential.

It should be obvious for persons skilled in the art that the present invention permits embodiments in numerous other specific forms without exceeding the field of application of the invention as claimed. Consequently, the present embodiments must be considered by way of illustration, but can be modified in the field defined by the scope of the attached claims, and the invention must not be limited to the details given above.

1. An intelligent electric switching device (1) designed to secure electric energy distribution systems comprising different power elements; electric switching device (1) is characterized in that it comprises, in a single physical unit:
an electric switch (10) through which an electric power network (7) passes:
a measurement means assembly (13) comprising one or more measurement means, each of a different type making physical measurements of the electric switching device (1),
a network communication means (12), connected to a communication network (8), said network being connected to power elements of the distribution system, said communication means (12) permitting sending characteristic parameters of the state of electric switching device (1) to communication network (8) and permitting receiving the characteristic parameters of the state of different power elements of the electric energy distribution system, connected to communication network (8);
a memory storage means (14) permitting storing all the data originating from the measurements conducted by measurement means assembly (13), and data received by the network communication means (12) on the characteristics of different power elements connected to the communication network (8);
a decision means (11) simultaneously and locally analyzing all the data stored in the memory storage means (13) and the measurements conducted, the decision device controlling the switching off or on of the electric switch (10) as a function of its analysis;
decision means (11) being connected to electric switch (10), to measurement means (13), to communication network means (12) and to memory storage means (14).

2. The electric switching device (1), according to claim 1, further characterized in that it functions in autonomous mode by means of measurement means assembly (13), memory storage means (14) and decision means (11), the decision means making decisions in a local manner on the basis of the measurements stored in memory storage means (14) as well as measurements conducted in real time.

3. The electric switching device (1), according to claim 1, further characterized in that electric switch (10) of electric switching device (1) comprises an insulating disk (103) provided with a conductive zone (104) crossing through disk (103), said disk (103) being driven in rotation by an axle (102), said axle (102) being moved directly by a motor (101) that can be controlled by decision means (11) or by a command button (100) situated on electric switch (10), the electrical contact of electric switch (10) being assured by means of at least two electrodes (105), one connected to current source (106), the other to the charge and being in contact with conductive zone (104) when electric switch (10) is in closed [“on”] position.

4. The electric switching device (1), according to claim 3, further characterized in that motor (101) of electric switch (10) supports manual mechanical activation.

5. The electric switching device (1), according to claim 1, further characterized in that it can still function in manual mode by activation, by a user, of command button (100) situated on electric switch (10), which by means of axle (102) of the switch will induce rotation of disk (103) and connect or disconnect power network (7).

6. The electric switching device (1), according to claim 1, further characterized in that it can function in network mode due to network communication means (12) and exchange data with power elements of the electric energy distribution system connected to communication network (8).

7. The electric switching device (1), according to claim 1, further characterized in that network communication means (12) is fixed telephonic of the optoelectronic or current-carrier type or that network communication means (12) is wireless of the radio type.

8. The electric switching device (1), according to claim 1, further characterized in that it can be inserted into an electric energy management network, said electric energy management network being connected to one or more power elements which belong to an electric energy distribution system, the electric energy management network comprising a power network (7) carrying electric energy and a communication network (8) carrying data concerning the management of electric energy, the two networks being connected to the power elements of the energy distribution system, said power elements being removable, interchangeable and each having their own decision means.

9. The electric switching device (1), according to claim 1, further characterized in that the electric energy management network can be connected to a control means (9) interfacing with a user, said interface permitting parameterizing the network, controlling the functions of the electric energy distribution system, and monitoring the state of all the elements connected to the network.

10. The electric switching device (1), according to claim 1, further characterized in that the electric management network operates in centralized mode when the communication network is fully available, permitting a user to set a certain number of commands of the electric energy distribution system by means of the control means.

11. The electric switching device (1), according to claim 1, further characterized in that the electric energy management network functions in decentralized mode, permitting all the elements of the electric energy distribution system to communicate with one another, each element being totally autonomous.

12. The electric switching device (1), according to claim 1, further characterized in that the electric energy management network functions in default mode, when the communication network is out of service, and the elements of the electric energy distribution system make their decision locally on the basis of their own measurements.
